(19) United States
(12) Patent Application Publication
(10) Pub. No.: US 2015/0368467 A1
(43) Pub. Date: Dec. 24, 2015

(54) THERMOPLASTIC POLYMER COMPOSITION AND MOULDED PARTS MADE THEREOF

(71) Applicant: DSM IP ASSETS B.V., Heerlen (NL)

(72) Inventors: Konraad Albert Louise Hector DULLAERT, Echt (NL); Zhujuan WANG, Echt (NL); Wilhelmus Josephus Maria SOUR, Echt (NL)

(21) Appl. No.: 14/838,259

(22) Filed: Aug. 27, 2015

Related U.S. Application Data
(63) Continuation of application No. 14/397,596, now abandoned.

(51) Int. Cl. C08L 81/04

(52) U.S. Cl. CPC C08L 81/04

(57) ABSTRACT

The invention relates a heat stabilized thermoplastic polymer composition comprising polyamide polymer and a heat stabilizer system, as well as moulded parts made thereof. The thermoplastic polymer composition comprises (A) a blend of at least two polyamide polymers comprising a first polyamide (a.1) being a semi-crystalline polyamide with a melting temperature of at least 240° C. and a second polyamide (a.2) being either polyamide 6 or a copolyamide of polyamide-6 and another polyamide, (B) a heat stabilizer system; and (C) a polyarylene sulfide polymer, wherein (A) and (C) are present in a weight ratio in the range of 90:10-20:80.

This application is a continuation of commonly owned copending U.S. application Ser. No. 14/397,596, filed Oct. 28, 2014 (now abandoned), which is the national phase application under 35 USC §371 of PCT/EP2012/058390, filed May 7, 2012 which designated the U.S. the entire contents of each of which are hereby incorporated by reference.

The invention relates a heat stabilized thermoplastic polymer composition comprising polyamide polymer and a heat stabilizer system, as well as moulded parts made thereof.

The invention more particular relates to heat stabilized thermoplastic polymer compositions that can be used in applications which reach use temperatures above 200° C. For that reason, the composition contains at least a semi-crystalline polyamide with a melting temperature of at least 240° C. Furthermore, the polymer composition comprises a heat stabilizer system, and preferably a heat stabilizer system that can provide longer term heat stability at temperatures above 200° C., more particular above 220° C. Such polymer compositions, and stabilizer systems used therein are known, for example, WO-2006/074934-A1, EP 1498445-A1, WO-2010/076145-A1, and WO-2010/014801-A1, which patents describe polyamide compositions with different type of stabilizer combinations.

The inventors have looked for ways to improve the long term heat stability of the thermoplastic polymer composition at temperatures above 200° C. Herein in particular the retention of mechanical properties, such as modulus, tensile strength and elongation are considered. One way was by combining the semi-crystalline polyamide with a melting temperature of at least 240° C. with a second polyamide, more particular with a polyamide 6 or a copolyamide of polyamide-6 and another polyamide. Though the long term heat stability was improved by the presence of the polyamide-6 or copolymer thereof, the parts moulded from the composition show significant blistering after exposure to temperatures above 220° C.

Therefore the aim of the present invention has been to provide eat stabilized thermoplastic polymer composition with good heat stability properties and reduced, or even better, absence of blistering.

This aim has been achieved with the heat stabilized thermoplastic polymer composition according to the invention, comprising
(A) a blend of at least two polyamide polymers comprising a first polyamide (a.1) being a semi-crystalline polyamide with a melting temperature of at least 240° C. and a second polyamide (a.2) being either polyamide 6 or a copolyamide of polyamide-6 and another polyamide, and
(B) a heat stabilizer system;
   wherein the composition further comprises at least
(C) a polyarylene sulfide polymer
   wherein (A) and (B) are present in a weight ratio in the range of 90:10-20:80.

The effect of the eat stabilized thermoplastic polymer composition according to the invention, comprising the blend (A) comprising the first polyamide with a melting temperature of at least 240° C. (component a.1) and the polyamide 6 or a copolyamide thereof (component a.2), in combination with the polyarylene sulfide polymer (component C) in the indicated ratio, is that the problem of blistering is reduced in large extent or even fully overcome while retaining the heat stability in sufficient extent. This result is surprising in particular in view of the fact that polyarylene sulfide polymers suffer in mechanical properties, e.g. are very brittle, and that various known compositions of blends of polyamides and polyarylene sulfide polymers tend to blister.

The first polyamide (a.1) in the polyamide polymer blend (A) in the thermoplastic polymer composition according to the invention can be any semi-crystalline thermoplastic polyamide that is suitable for making thermoplastic moulding compositions, and which has a melting temperature of at least 240° C. Preferably (a.1) comprises a semi-crystalline thermoplastic polyamide having a melting temperature in the range of 250-340° C.

The melting temperature (referred to as Tm) is herein understood to be the melting measured on pre-dried samples by the method according to ISO-11357-3.2, 2009, in an N₂ atmosphere with heating and cooling rate of 10° C./min, and determined for the second heating curve.

Examples of suitable high melting polyamides include semi-aromatic polyamides like PA9T, PA4T/6T-copolyamides and PA66/6T-copolyamides, and aliphatic polyamides like PA46 and PA66.

The second polyamide (a.2) in the polyamide polymer blend (A) is polyamide-6 or a copolyamide of polyamide-6 and another polyamide. The copolyamide may be, for example a block copolyamide, or a random copolyamide. An example of such copolyamide is polyamide 6,6/6, which is a copolyamide made from caprolactam, hexamethylene diamine and adipic acid.

Preferably (a.2) consists for at least 50 wt. % of polyamide-6. The wt. % is relative to the total weight of the second polyamide (a.2). More preferably, (a.2) consists for at least 75 wt. %, or even better at least 90 wt. % of polyamide-6.

The blend (A) may vary in composition and also the ratio of (a.1) and (a.2) may vary over a wide range. A small amount of the second polyamide (a.2) can already bring an effect on the thermal properties, but if not combined with component (C) as in the present invention that would also affect the blistering. In combination with component (C) also a high amount of component (a.2) can be allowed, without causing blistering and without affecting too much of the mechanical properties of the first polyamide (a.1). Suitably, (a.1) and (a.2) are present in a weight ratio in the range of 95:05-25:75. Preferably, the ratio is in the range of 85:15-40:60.

The polyarylene sulfide polymer (component C) in the thermoplastic polymer composition according to the invention can be any thermoplastic polyarylene sulfide polymer that is suitable for making thermoplastic moulding compositions. Suitably the polyarylene sulfide polymer is a semi-crystalline thermoplastic polymer. Such a polymer can be characterised by its melting temperature. In a preferred embodiment of the invention (C) comprises a polyarylene sulfide having a melting temperature of at least 250° C. More preferably, the melting temperature (Tm-PPS) is in the range of 270-340° C.

Examples of suitable semi-crystalline polyarylene sulfides are polyphenylene sulfides and polybiphenylene sulfides. Preferably (C) comprises a polyphenylene sulfide polymer. This polyphenylene sulfide polymer suitably has a melting temperature in the range of 270-340° C. and optionally is blended with another polyarylene sulfide polymer, being either a semi-crystalline thermoplastic polyarylene sulfide polymer having a Tm lower than 270° C. and/or an amorphous thermoplastic polyarylene sulfide polymer.

The composition according to the invention comprises a combination of a polyamide polymer blend (component A) and a polyarylene sulfide polymer (component C). (A) and (C) are present in a weight ratio of 90:10-20:80. Preferably, this ratio is in the range of 80:20-30:70, more preferably 70:30-40:60. This further improves the balance in properties of the polyamide and the polyarylene sulphide. The advantage is that the thermoplastic polymer composition has an even better combination of properties.

Not only the relative amounts of (A) and (C) may vary. Also the total amount of (A) and (C) in the composition may vary over a large range because the composition may comprise other components like fillers and reinforcing agents which can be present in variable amounts. Suitably the total amount of (A) and (C) is, for example, in the range of 30-99 wt. %. In the compositions, the amount of (A), as well as that of (C), may well be in the range of 10-60 wt. %, or even 20-50 wt. %, provided that the total amount stays below 100 wt. %. The total amount of (A) and (C) may well be in the range of 40-90 wt. %, or more particular 50-80 wt. %. Herein the wt. % are relative to the total weight of the composition.

The thermoplastic polymer composition according to the invention comprises as component (B) a heat stabilizer system. Stabilizer components used in stabilizer systems used for thermoplastic polyamide compositions include inorganic compounds such as metals, oxides and salts, organic stabilizers, such as phenolic stabilizers, phosphite stabilizers, aromatic amines, and polymeric stabilizers, such as polyols and polyamines. The stabilizer system in the present invention typically comprises at least two stabilizer components. In a preferred embodiment, heat stabilizer system (B) is suitable for and present in an effective amount for providing long term heat stability at temperatures above 200° C. Examples of such stabilizer systems are described in WO-2006/074934-A1, EP 1498445-A1, WO-2010/076145-A1, and WO-2010/014801-A1, which are herein incorporated by reference.

In a preferred embodiment of the thermoplastic polymer composition according to the invention, the stabilizer system (B) comprises at least two components chosen from at least two of the following three groups:
1. inorganic components chosen from the group consisting of (a) elementary metals, (b) metal oxides and (c) metal salts, wherein the metal in elementary metals, the metal oxides and the metal salts is a transition metal element from Group VB, VIB, VIIB and VIIIB of the Periodic Table;
2. organic polyfunctional components chosen from the group consisting of (a) polyhydric alcohols and (b) polyamines; and
3. stabilizers chosen from the group consisting of phenolic stabilizers, phosphite stabilizers, aromatic amines, copper containing stabilizers and alkali halides.

The requirement that the composition comprises at least two components chosen from at least two of the said three groups, is herein to be understood that the composition shall comprise at least one component selected from one of the three groups B(i), B(ii) and B(iii) and at least one component selected from one of the other two groups within B(i), B(ii) and B(iii). For example, a component selected from group B(i) has to be combined with a component from group B(ii) or B(iii). Analogously a component selected from group B(ii) has to be combined with a component from group B(i) or B(iii). (B) may comprise multiple components selected from the same group. (B) may also comprise three or more components selected from all three groups B(i), B(ii) and B(iii).

A polyhydric alcohol is herein understood to be a polyhydroxy functional component with three or more alcohol groups.

A polyamine is herein understood to be a polyamino functional component with three or more primary and/or secondary amino groups).

Transition metal element from Group VB, VIB, VIIB and VIIIB of the Periodic Table, referred herein as “Group VB-VIIIB transition metals”, include the following metals: Group VB: vanadium (V), niobium (Nb), tantalium (Ta); Group VIB: chromium (Cr), molybdenum (Mo), and tungsten (W), Group VIIB: manganese (Mn), technetium (Tc) and rhenium (Re); and Group VIIIB: iron (Fe), ruthenium (Ru), osmium (Os), cobalt (Co), rhodium (Rh), iridium (Ir), nickel (Ni), palladium (Pd), and platinum (Pt).

In case of a component from group (B.i), the transition metal preferably comprises iron. With iron as the transition metal, elementary iron, an oxide of iron, or an iron salt, or any mixture thereof can be used.

Suitable iron oxides include FeO, Fe2O3, or Fe3O4 or a mixture thereof. Suitable iron salts include ferrites, such as Zn-ferrite and Mg-ferrite, and iron phosphorus oxides, i.e. salts of iron oxides with phosphor based acids, like iron phosphate and ironhypophosphate.

Preferably, the elementary metal consists of a metal powder having a median particle size (D₅₀) of at most 250 μm. Also the metal oxide preferably consists of particles having a median particle size (D₅₀). More preferably, the elementary metal, respectively the metal oxide has a median particle size (D₅₀) of at most 100 μm, still more preferably at most 25 μm and still more preferably at most 10 μm. Suitably, the median particle size (D₅₀) is in the range of 1-5 μm or even below 1 μm. The advantage of a smaller particle size and in particular a smaller median particle size for the elementary metal, respectively the metal oxide is that the heat ageing properties of the inventive composition is further improved or that the elementary metal, respectively the metal oxide, or combination thereof, can be used in a smaller amount for obtaining the same properties. With the term median particle size (D₅₀) is herein understood the median particle size determined with sieve methods, according to

ASTM standard D1921-89, method A.

A suitable metal powder (B(i)(a)) is, for example, SCM IronPowder A 131, obtainable from SCM Metal Products. A suitable metal oxide is, for example, Sicotrans Red K2915, Fe2O3 powder with a D50=400 nm, available from BASF.

The amount of the inorganic components B(i), when used, is preferably in the range of 0.005-5 wt. %, more preferably 0.05-2 wt. %. Examples of suitable amounts are 0.1 wt. %, 0.5 wt. % and 1 wt. %. Herein the wt. % are relative to the total weight of the polymer composition.

The polyhydric alcohols (B(ii)(a)) that can be used in the thermoplastic polymer composition according to the invention, can have a molecular weight varying over a wide range. The weight average molecular weight (Mw) suitably is in the range of 100-3.000.000, for example 1.000, 10.000, 100.00 and 1.000.000. Suitable polyhydric alcohols include low molecular weight polyhydric alcohols, such as pentaerythritol, and low molecular weight oligomers thereof, for example dipentaerythritol, and tripentaerythritol, and polymers and copolymers of hydroxyl functional monomers, such as polyvinyl alcohol and ethylene/vinyl alcohol copolymer. Such (co)polymers and other polyhydric alcohols used in the present invention suitably have a number average molecular weight of at least 2000 g/mole. In a particular embodiment the polyhydric alcohol has a melting temperature in the range of 150-280° C.

For the polyamines (B(ii)(b)) in the thermoplastic polymer composition according to the invention, for example polyethyleneimine polymers can be used. Suitably the polyethyleneimine polymer is selected from homopolymers of ethyleneimine, copolymers of ethyleneimine and amines having at least two amino groups, crosslinked polyethyleneimines, grafted polyethyleneimines, The polyamines can be either linear or branched polymer, or a mixture thereof. The polyamines may comprise tertiary amine groups next to primary amines and/or secondary amines. Suitably the ratio is of primary/secondary/tertiary amine groups herein is in the range of 1/0,7-1,4/0,3-1,1/ bis 1/0,8-1,3/0,5-0,9. Also the molecular weight of the polyamines may vary over a wide range. The weight average molecular weight (Mw) suitably is in the range of 100-3.000.000, for example 1.000, 10.000, 100.00 and 1.000.000.

The amount of the organic components B(ii), when used, is preferably in the range of 0.005-5 wt. %, more preferably 0.05-2 wt. %. Suitable amounts are, for example, 0.1 wt. %, 0.5 wt. % and 1 wt. %. Herein the wt. % are relative to the total weight of the polymer composition.

For the various stabilizer components B(iii), for example the following components can be used: for phenolic stabilizers (also known phenolic antioxidants), typically hindered phenols are used, for example hindered phenols which sterically hindered phenol is formed from N,N′-hexamethylenebis-3,5-di-tert-butyl-4-hydroxyhydrocinnamide. As phosphite stabilizers, compounds such as phosphites, phosphonites and hypophosphites; can be used. An example is sodium hypophosphite (NaHPO3), which are preferably be used in combination with iron powder or iron oxide. Also aromatic amines may be used. As the copper containing stabilizers, copper salts such as copper halogenides can be used. The copper salt preferably comprises copper bromides and/or copper iodides. For the alkali halides, any alkali halide can be used, e.g. sodium and potassium chloride, bromide and/or or iodide are used. Preferably bromides and iodides are used, most preferably potassium iodide. The composition suitably contains mixtures of copper salts and halogenides, for example copper iodide/potassium iodide compositions.

In case the composition comprises a copper containing stabilizer, preferably it also comprises an alkali halide. The copper containing stabilizer and alkali halide are suitably present in a weight ratio of at least 5:1, preferably at least 1:1, more preferably at least 1:5.

The amount of stabilizer components B(iii), when used, is preferably in the range of 0.005-10 wt. %. For the alkali halide to be effective, generally the amount thereof is of the alkali halide may be such that In case B(iii) includes an alkali halide, the total amount of B(iii) is preferably in the range of 1-10 wt. %, more preferably 2-7.5 wt. %. In case no such alkali halide is present, the total amount of B(iii) is preferably in the range 0.05-2 wt. %, more preferably 0.1-1.5 wt. Herein the wt. % are relative to the total weight of the polymer composition.

In a preferred embodiment, the (B) comprises at least one component chosen from group B(i) and at least a component chosen from group B(ii)(a) or B(ii)(b).

In another preferred embodiment, (B) comprises at least an alkali halide/and or copper halide and at least a component chosen from group B(i) and/or at least a component chosen from group B(ii).

Such embodiments are examples of compositions that result in very good heat ageing properties, meanwhile showing little to no blistering.

The heat stabilizer system (B) consists of multiple components, which can each be present in different amounts, and amounting to a total amount for (B), which can vary over a wide range. Suitably, the heat stabilizer system (B) is present in an amount in the range of 0.01-10 wt. %, preferably 0.1-5 wt. %, relative to the total weight of the composition. More specifically, this combined amount of components (C) is preferably in the range of 0.02-15 wt. %, more preferably 0.2-10 wt. %, still more preferably 0.5-5 wt. %, relative to the weight of the polyamide polymer.

In case that the thermoplastic polymer composition has a multiphase structure comprising a polyamide phase and a polyarylene phase, it is preferred that at least 50 wt. % of heat stabilizer system (B) is comprised in the polyamide phase. This can be achieved by precompounding component (A) with at 50 wt. % of heat stabilizer system (B), prior to compounding (A) with (C).

The thermoplastic polymer composition according to the invention, may comprise, next to components (A), (B) and (C), further components, including reinforcement agents, inorganic fillers and flame retardants (D), and additives (E) other than A, B, C and D

The reinforcement agent can be any reinforcement agent, or combination of reinforcement agents, suitable for use in thermoplastic polyamide and/or polyarylene moulding compositions, which reinforcement agents include, for example, glass fibres and carbon fibres.

The filler can be any filler, or combination of fillers, suitable for use in thermoplastic polyamide and/or polyarylene moulding compositions, which fillers include, for example, calcium carbonate.

The flame retardant can be any flame retardant, or flame retardant system, suitable for use in thermoplastic polyamide and/or polyarylene moulding compositions. Suitably, the flame retardant is blended in the polyamide phase.

Also compatibilizers can be added to control and stabilize the morphology of the separate polyamide and polyarylene sulfide phases. As compatibilizers both particles (e.g. clay particles, carbon nanotubes) and oligomers/copolymers (e.g. styrene-b-ethylene/butylene-b-styrene triblock copolymer (SEBS) or maleic anhydride grafted SEBS (SEBS-g-MA)) can be used.

The additive (E) can be any additive, such as auxiliary additives generally used in thermoplastic moulding compositions, which include processing aids, for example metal salts of fatty acid salts, solid lubricants, for example PTFE, MoS2 and graphite, and pigments and colorants, for example carbon black and nigrosine.

The thermoplastic polymer composition suitably comprises (D) 0-60 wt. %, preferably 10-50 wt %, of one or more reinforcement agents and/or inorganic fillers.

The thermoplastic polymer composition also suitably comprises (E) 0-20 wt. %, preferably 1-10 wt. %, of one or more additives.

Herein the weight percentages (wt. %) are relative to the total weight of the composition.

The polymer composition according to the invention can be prepared by conventional melt blending processes, comprising melt blending of a polyamide polymer containing material (I) and a polyarylene containing material (II). Whereas polyamide polymers and polyarylene polymers typically are not miscible on a molecular scale, such a process generally results in a polymer composition having a multiphase structure including a polyamide phase, or polyamide rich phase (together referred to as polyamide phase) and a polyarylene phase, or polyarylene rich phase (together referred to as polyarylene phase).

The invention also relates to a moulded part comprising a thermoplastic polymer composition according to the invention, or any preferred or particular embodiment thereof. The moulded part can be, for example, an injection moulded part or an extrusion moulded part, more particular an extrusion blow moulded part. Such moulded parts can be produced by conventional processes using standard equipment generally applied for making moulded parts, including, for example, injection moulding processes and extrusion moulding processes.

Examples of such parts are, for example, gears, bushing, gaskets, bearings and oil well drilling parts, as well as automotive parts, such as air ducts, for example for use in turbo applications.

The invention is further illustrated with the following example and comparative experiments.

### MATERIALS

For the preparation of the compositions the following components have been used.

PA6 Polyamide 6, type K122, viscosity number 115 ml/g (measured according to ISO 307) (ex DSM, The Netherlands)

PA46 Polyamide-4,6, type KS200, viscosity number 160 ml/g (measured according to ISO 307); melting temperature 290° C. (ex DSM, The Netherlands);

GF Glass fibres Reinforcing agent: standard type for polyamides

PPS Poly(1,4-phenylene sulfide) average Mn ˜10,000, powder (Grade 182354 ex Sigma Aldrich)

Fe SCM IronPowder A 131, obtainable from SCM Metal Products.

CuI/KI Copper Iodide/particle size<109 μm; Potassium Iodide (ex Sigma-Aldrich Chemie BV).

AA Auxiliary additives, including lubricant and the carrier polymer used for the masterbatch of the iron powder.

Table 1 shows a composition according to the present invention (Example I) and two comparative experiments (CE-A and CE-B). For the preparation a masterbatch of iron powder (20 wt. %) in polyethylene was used. The compositions have been prepared by conventional melt mixing processes used for preparing polyamide compositions from polyamide, respectively bends of polyamides and polyarylene sulfide polymers. The compositions were moulded into test bars. The test bars were subjected to heat ageing tests for 500 hours at 230° C., after which mechanical properties were tested and occurrence of blistering was inspected.

The results show that the composition according to the examples, shows no blistering while also showing very good properties, whereas comparative examples either show blistering or less good mechanical properties after heat ageing

TABLE 1
Composition and test results for Example
I and Comparative Experiments A and B.

| Experiments | CE-A | CE-B | EX-I |
|---|---|---|---|
| Compositions (in wt. %) | | | |
| PA46 | 55 | 27.5 | 13.75 |
| PA6 | 0 | 27.5 | 13.75 |
| PPS | 0 | 0 | 27.5 |
| Fe-masterbatch | 0.5 | 0.5 | 0.5 |
| Cul/KCl | 0.5 | 0.5 | 0.5 |
| GF | 40 | 40 | 40 |
| Aux. Add. | 4.0 | 4.0 | 4.0 |
| Ratinq of test Results ^{a)} | | | |
| Mechanical properties after | + | +++ | ++ |
| Heat Ageing | | | |
| Blistering | + | − | + |

^{a)} “−” = bad, “+” = good, “++” = very good; “+++” = excellent

1. Thermoplastic polymer composition comprising
(A) a blend of at least two polyamide polymers comprising a first polyamide (a.1) being a semi-crystalline polyamide with a melting temperature of at least 240° C. and a second polyamide (a.2) being either polyamide 6 or a copolyamide of polyamide-6 and another polyamide, and
(B) a heat stabilizer system;
wherein the composition further comprises at least
(C) a polyarylene sulfide polymer, and
wherein (A) and (C) are present in a weight ratio in the range of 90:10-20:80.

2. Thermoplastic polymer composition according to claim 1, wherein the second polyamide consists for at least 50 wt. % of polyamide-6 .

3. Thermoplastic polymer composition according to claim 1, wherein (a.1) and (a.2) are present in a weight ratio in the range of 95:05-35:65.

4. Thermoplastic polymer composition according to claim 1, wherein (C) comprises a polyarylene sulfide having a melting temperature (Tm-PAS) of at least 250° C.

5. Thermoplastic polymer composition according to claim 1, wherein (A) and (C) are present in a weight ratio in the range of 80:20-30:70, preferably 70:30-40:60.

6. Thermoplastic polymer composition according to claim 1, wherein the heat stabilizer system (B) is suitable for and present in a effective amount for providing long term heat stability at temperatures above 200° C.

7. Thermoplastic polymer composition according to claim 1, wherein the heat stabilizer system (B) is present in an amount in the range of 0.01-10 wt. %, relative to the total weight of the composition.

8. Thermoplastic polymer composition according to claim 1, further comprising
(D) 0-60 wt. %, preferably 10-50 wt %, of one or more reinforcement agents and/or inorganic fillers, and
(E) 0-20 wt. %, preferably 1-10 wt. %, of one or more additives,
wherein the weight percentages (wt. %) are relative to the total weight of the composition.

9. Moulded part comprising a thermoplastic polymer composition according to claim 1.

10. Moulded part according to claim 9, being a gear, a bushing, a gasket, a bearing, an oil well drilling parts, or an automotive parts.

11. Moulded part which is an air duct which is extrusion blow-moulded from the composition of claim 1.
